(19) United States
(12) Patent Application Publication
(10) Pub. No.: US 2021/0356789 A1
(43) Pub. Date: Nov. 18, 2021

(54) LIQUID CRYSTAL DISPLAY PANEL, METHOD OF FABRICATING SAME, AND LIQUID CRYSTAL DISPLAY DEVICE

(71) Applicant: WUHAN CHINA STAR OPTOELECTRONICS TECHNOLOGY CO., LTD., Wuhan, Hubei (CN)

(72) Inventor: Wei CHENG, Wuhan, Hubei (CN)

(21) Appl. No.: 16/625,718

(22) PCT Filed: Oct. 18, 2019
(86) PCT No.: PCT/CN2019/111903

§ 371 Date: Dec. 22, 2019

(30) Foreign Application Priority Data
May 14, 2019 (CN) 201910396159.2

(51) Int. Cl. G02F 1/1339; G02F 1/1334; G02F 1/1333; G02F 1/1341; H04M 1/02

(52) U.S. Cl. CPC G02F 1/13394; G02F 1/1334; H04M 1/0266; G02F 1/1341; G02F 1/133345

(57) ABSTRACT

The present invention provides a liquid crystal display panel, a method of fabricating the same, and a liquid crystal display device, wherein the liquid crystal display panel includes an electronic component area corresponding to a position at which an electronic component is disposed, wherein the electronic component area is provided with polymer dispersed liquid crystals, which are processed to form retaining walls and liquid crystals located between the retaining walls, such that the electronic component area and the display area can be separated by the retaining walls instead of being separated by a border, which solves the technical problem that the display screen of the existing mobile phone display screen has a border between the notch area and the display area.

### BACKGROUND OF INVENTION

### Field of Invention

The present invention relates to a field of display technologies, and in particular, to a liquid crystal display panel, a method of fabricating the same, and a liquid crystal display device.

### Description of Prior Art

As shown in FIG. 1, in an existing mobile phone, in order to set a front camera, a notch area is dug out of a display screen for allowing disposition of the front camera. Because the front camera needs to be packaged by a sealant, a large black border will be created at a boundary between the notch area and a display area, impacting the display.

Therefore, the display screen of the existing mobile has a technical problem that a border is present between the notch area and the display area.

### SUMMARY OF INVENTION

The present invention provides a liquid crystal display panel, a method of fabricating the same, and a liquid crystal display device, which are used to solve the technical problem that the display screen of the existing mobile phone display screen has a border between the notch area and the display area.

To solve the above problems, the technical solution provided by the present invention is as follows:

The present invention provides a liquid crystal display panel including an electronic component area corresponding to a position at which an electronic component is disposed, wherein the electronic component area is provided with polymer dispersed liquid crystals, which are processed to form retaining walls and liquid crystals located between the retaining walls.

In the liquid crystal display panel provided by the present invention, a display area is further included, wherein the display area includes a first display area and a second display area located between the first display area and the electronic component area, the second display area includes a first metal trace, and material of the first metal trace includes a transparent material.

In the liquid crystal display panel provided by the present invention, a display area is further included, wherein the display area includes a first metal layer, and material of the first metal layer includes a transparent material.

In the liquid crystal display panel provided by the present invention, the display area includes a second metal layer and an insulating layer, the insulating layer is disposed between the first metal layer and the second metal layer, and material of the second metal layer includes a transparent material.

The liquid crystal display panel provided by the present invention further includes a display area and a sealant area, wherein the electronic component area is disposed at a side of the display area, the electronic component area is disposed outside of the display area, and the sealant area is disposed around a boundary of the liquid crystal display panel.

In the liquid crystal display panel provided by the present invention, the electronic component area has a semicircular shape.

In the liquid crystal display panel provided by the present invention, the electronic component area has a trapezoidal shape.

In the liquid crystal display panel provided by the present invention, a display area and a sealant area are further included, wherein the display area is disposed around the electronic component area, and the sealant area is disposed around the display area.

In the liquid crystal display panel provided by the present invention, the electronic component area has a circular shape.

In the meantime, the present invention provides a method of fabricating a liquid crystal display panel, and the method of fabricating the liquid crystal display panel includes: providing a liquid crystal display panel, the liquid crystal display panel including an electronic component area corresponding to a position at which an electronic component is disposed; injecting polymer dispersed liquid crystals into the liquid crystal display panel; and irradiating the electronic component area, to cause the polymer dispersed liquid crystals in the electronic component area to form retaining walls and liquid crystals, wherein the liquid crystals are located between the retaining walls.

In the liquid crystal display panel manufacturing method provided by the present invention, the step of irradiating the electronic component area includes: irradiating the electronic component area with ultraviolet light through a mask.

Meanwhile, the present invention provides a liquid crystal display device including a liquid crystal display panel, a backlight module, and an electronic component, wherein the liquid crystal display panel includes an electronic component area corresponding to a position at which an electronic component is disposed, wherein the electronic component area is provided with polymer dispersed liquid crystals, which are processed to form retaining walls and liquid crystals located between the retaining walls.

In the liquid crystal display device provided by the present invention, the liquid crystal display panel further includes a display area, the display area including a first display area and a second display area located between the first display area and the electronic component area, the second display area including a first metal trace, and material of the first metal trace being a transparent material.

In the liquid crystal display device provided by the present invention, the liquid crystal display panel further includes a display area, the display area including a first metal layer, and material of the first metal layer includes a transparent material.

In the liquid crystal display device provided by the present invention, the display area includes a second metal layer and an insulating layer, the insulating layer being disposed between the first metal layer and the second metal layer, and material of the second metal layer being a transparent material.

In the liquid crystal display device provided by the present invention, the liquid crystal display panel further includes a display area and a sealant area, wherein the electronic component area is disposed at a side of the display area, the electronic component arranging area is disposed outside of the display area, and the sealant area is disposed around a boundary of the liquid crystal display panel.

In the liquid crystal display device provided by the present invention, the electronic component area has a semicircular shape.

In the liquid crystal display device provided by the present invention, the shape of the electronic component area has a trapezoidal shape.

In the liquid crystal display device provided by the present invention, the liquid crystal display panel further includes a display area and a sealant area, the display area is disposed around the electronic component arranging area, and the sealant area is disposed around the display area.

In the liquid crystal display device provided by the present invention, the electronic component area has a circular shape.

The present invention provides a liquid crystal display panel, a method of fabricating the same, and a liquid crystal display device, wherein the liquid crystal display panel includes an electronic component area corresponding to a position at which an electronic component is disposed, wherein the electronic component area is provided with polymer dispersed liquid crystals, which are processed to form retaining walls and liquid crystals located between the retaining walls. By disposing polymer dispersed liquid crystals in the electronic component area, and processing the polymer dispersed liquid crystals to form the retaining walls and the liquid crystals, the electronic component area and the display area can be separated by the retaining walls instead of being separated by a border, thereby eliminating the border between the electronic component area and the display area, thus improving the screen-to-body ratio. Moreover, the liquid crystals and the retaining walls are transparent, so that the electronic component area can normally transmit light, which solves the technical problem that the display screen of the existing mobile phone display screen has a border between the notch area and the display area.

### BRIEF DESCRIPTION OF DRAWINGS

In order to more clearly illustrate the embodiments or the technical solutions of the existing art, the drawings illustrating the embodiments or the existing art will be briefly described below. Obviously, the drawings in the following description merely illustrate some embodiments of the present invention. Other drawings may also be obtained by those skilled in the art according to these figures without paying creative work.

FIG. 1 is a schematic diagram of a display screen of a conventional mobile phone.

FIG. 2 is a schematic diagram of a liquid crystal display panel according to a first embodiment of the present invention.

FIG. 3 is a schematic diagram of a liquid crystal display panel according to a second embodiment of the present invention.

FIG. 4 is a schematic diagram of a liquid crystal display panel according to a third embodiment of the present invention.

FIG. 5 is a schematic diagram of a liquid crystal display panel according to a fourth embodiment of the present invention.

FIG. 6 is a flowchart of a method of fabricating a liquid crystal display panel according to an embodiment of the present invention.

### DETAILED DESCRIPTION OF PREFERRED EMBODIMENTS

The following description of the various embodiments is provided to illustrate the specific embodiments of the invention. Directional terms mentioned in the present invention, such as “vertical”, “horizontal”, “upper”, “bottom”, “pre”, “post”, “left”, “right”, “inside”, “outside”, “side”, etc., only refer to the direction of the additional drawing. Therefore, the directional terminology used is for the purpose of illustration and understanding of the invention. In the figures, structurally similar elements are denoted by the same reference numerals.

The present invention is directed to the technical problem that the existing mobile phone display screen has a border at a boundary between the notch area and the display area, and embodiments of the present invention are provided to solves the problem.

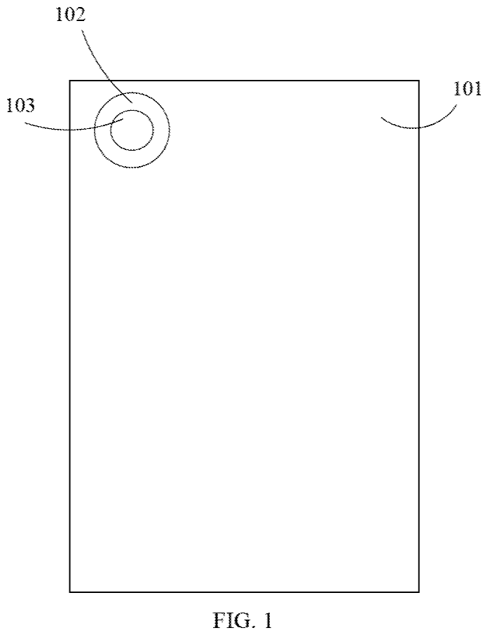

As shown in FIG. 1, in order to set a front camera, a notch area 103 is dug out of a display screen of an existing mobile phone for allowing disposition of the front camera. Because the notch area 103 and a display area 101 need to be packaged by a sealant, a large black border will be created at a boundary 102 between the notch area 103 and the display area 101, impacting the display, that is, the existing mobile phone display screen has a technical problem that a border exists between the notch area and the display area.

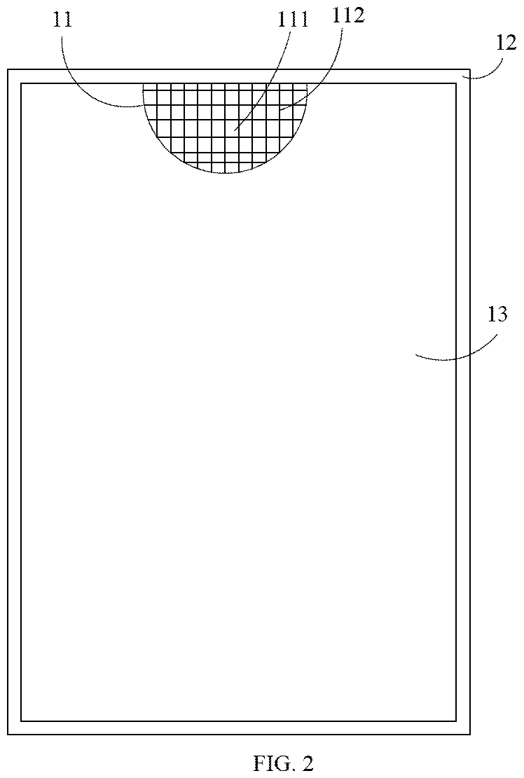

As shown in FIG. 2, an embodiment of the present invention provides a liquid crystal display panel including an electronic component area 11 corresponding to a position at which an electronic component is disposed, wherein the electronic component area 11 is provided with polymer dispersed liquid crystals, which are processed to form retaining walls 112 and liquid crystals 111 located between the retaining walls 112.

Embodiments of the present invention provide a liquid crystal display panel including an electronic component area corresponding to a position at which an electronic component is disposed, wherein the electronic component area is provided with polymer dispersed liquid crystals, which are processed to form retaining walls and liquid crystals located between the retaining walls. By disposing polymer dispersed liquid crystals in the electronic component area, and processing the polymer dispersed liquid crystals to form the retaining walls and the liquid crystals, the electronic component area and the display area can be separated by the retaining walls instead of being separated by a border, thereby eliminating the border between the electronic component area and the display area, thus improving the screen-to-body ratio. Moreover, the liquid crystals and the retaining walls are transparent, so that the electronic component area can normally transmit light, which solves the technical problem that the display screen of the existing mobile phone display screen has a border between the notch area and the display area.

It should be noted that in FIG. 2, the polymer dispersed liquid crystals have been formed into the retaining walls and the liquid crystals, and the polymer dispersed liquid crystals are not shown in FIG. 2.

In an embodiment, as shown in FIG. 2, the liquid crystal display panel further includes a display area 13 and a sealant area 12, wherein the electronic component area 11 is disposed at a side of the display area 13, the electronic component area 11 is disposed outside of the display area 13, and the sealant area 12 is disposed around a boundary of the liquid crystal display panel. For a liquid crystal display panel having an electronic component area formed at least one of four sides of the display area, for example, in FIG. 2, when the electronic component area is disposed on the upper side of the display area, and the electronic component area is exposed in the display area, by setting the sealant area around the boundary of the liquid crystal display panel, and then, by injecting the polymer dispersed liquid crystals into the sealant area, that is, into the position corresponding to the electronic component area and the display area, the liquid crystals and the retaining walls are formed in the electronic component area by processing the polymer dispersed liquid crystals in the electronic component area. Therefore, the electronic component area and the display area are separated by the retaining walls instead of being separated by a border, thereby realizing direct connection between the liquid crystal display panel display area and the electronic component area, thus enlarging a size of the display area of the liquid crystal display panel, increasing the screen-to-body ratio, and solving the technical problem that the mobile phone display screen has a border between the notch area and the display area.

In an embodiment, the electronic component area has a semicircular shape.

In an embodiment, the electronic component area has a trapezoidal shape.

In the existing liquid crystal display panel, when there is a portion in the electronic component area that is not in contact with the display area, for example, the electronic component area is disposed on an upper side of the liquid crystal display panel, a sealant needs to be set at the boundary of the display area, that is, the sealant has a notched shape, which is difficult to be fabricated, thus reducing production efficiency. In this embodiment of the present invention, as shown in FIG. 2, the sealant area is disposed around the boundary of the liquid crystal display panel, and the sealant area is nearly rectangular or rectangular, without the notch area, such that the sealant

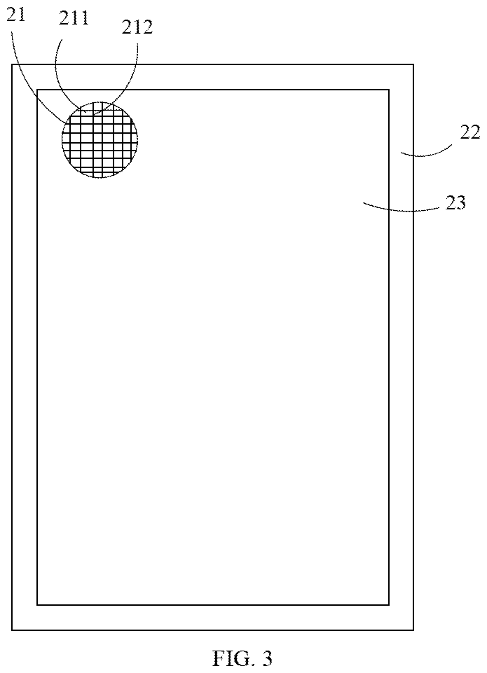

As shown in FIG. 3, an embodiment of the present invention provides a liquid crystal display panel including an electronic component area 21 corresponding to a position at which an electronic component is disposed, a display area 23, and a sealant area 22, wherein the electronic component area 21 is provided with polymer dispersed liquid crystals, which are processed to form retaining walls 212 and liquid crystals 211 located between the retaining walls 212. The display area 23 is disposed around the electronic component area 21, and the sealant area 22 is disposed around the display area 23. For the liquid crystal display panel in which the display area is disposed around the electronic component area, the polymer dispersed liquid crystals of the electronic component area are processed to form the liquid crystals and the retaining walls, thereby causing the electronic component area and the display area to be separated without a border between the electronic component area and the display area, which improves the screen-to-body ratio, and solves the technical problem that the mobile phone display screen has a border between the notch area and the display area.

In an embodiment, the electronic component area has a circular shape, but embodiments of the present invention are not limited thereto. For example, for better display effect, the electronic component area may be set to have an elliptical shape.

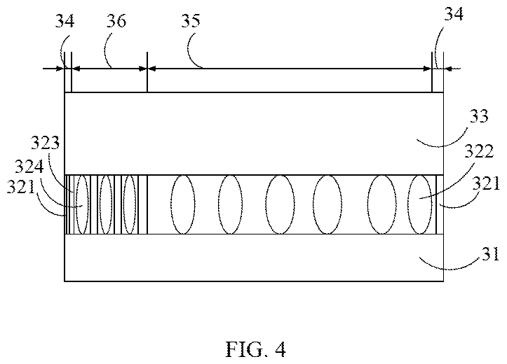

As shown in FIG. 4, the embodiment of the present invention provides a liquid crystal display panel including a first substrate 31, a second substrate 33, and a liquid crystal cell between the first substrate 31 and the second substrate 33. Polymer dispersed liquid crystals 322 are disposed in the liquid crystal cell, and the polymer dispersed liquid crystals 322 are disposed in an area corresponding to the display area 35. In an area corresponding to the electronic component area 36, the polymer dispersed liquid crystals are processed to form retaining walls 323 and liquid crystals 324, and a sealant 321 is provided in an area corresponding to the sealant area 34.

In this embodiment of the present invention, as can be seen from FIG. 4, the polymer dispersing liquid crystals are injected into the liquid crystal cell, and the polymer dispersed liquid crystals corresponding to the area of the electronic component area is processed, so that the electronic component area forms the retaining walls and the liquid crystals. Therefore, the electronic component area and the display area are separated by the retaining walls, and the polymer dispersed liquid crystals of the display area can work normally, causing the display area to normally display. In addition, since the polymer dispersed liquid crystals are injected over the entire surface, the sealant can surround the display area and the electronic component area, which is easier to be fabricated, thus improving the fabrication efficiency.

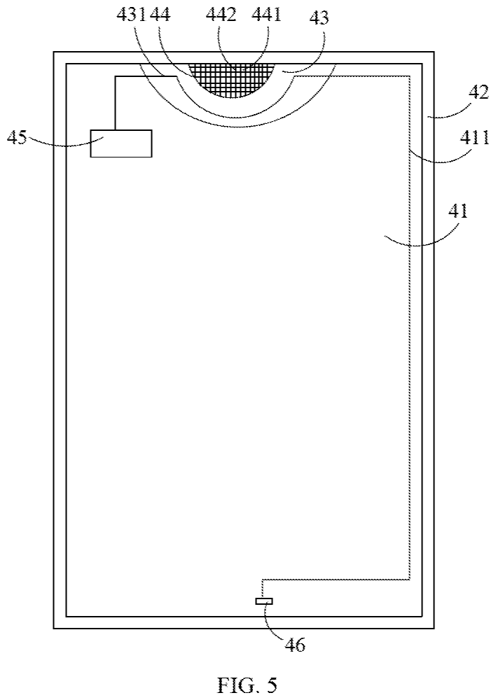

As shown in FIG. 5, this embodiment of the present invention provides a liquid crystal display panel including an electronic component area 44, a first display area 41, a second display area 43, and a sealant area 42. The electronic component area 44 is provided with retaining walls 442 and liquid crystals 441. The second display area 43 is located between the first display area 41 and the electronic component area 44. The second display area 43 includes a first metal trace. The second display area 41 includes a second metal trace 411. The first metal trace 431 is connected to the second metal trace 411 and a pixel unit 45. The second metal trace 411 and the first metal trace 431 are connected to a signal terminal 46. Material of the first metal trace 431 is a transparent material. By setting the material of the first metal trace as a transparent material, the first metal trace does not impact transmission of the electronic component area, such that the electronic component area can normally transmit light.

In an embodiment, a metal trace at the boundary between the second display area and the electronic component area is made of a transparent material. For the metal trace disposed around the boundary between the second display area and the electronic component area, the transparent material is used to fabricate the metal trace, so that the electronic component area can normally transmit light, without impacting a normal operation of the electronic component area.

In an embodiment, the liquid crystal display panel includes a display area, wherein the display area includes a first metal layer, and material of the first metal layer is a transparent material. By setting the material of the first metal trace as a transparent material, the metal trace disposed around the boundary between the display area and the electronic component area is made of a transparent material, such that the first metal trace does not impact transmission of the electronic component area, and the electronic component area can normally transmit light.

In an embodiment, the liquid crystal display panel includes a display area, wherein the display area includes a second metal layer and an insulating layer, and the insulating layer is disposed between the first metal layer and the second metal layer. Material of the second metal layer is a transparent material. By setting the material of the second metal trace as a transparent material, the metal trace provided by the second metal layer around the boundary between the display area and the electronic component installation area is transparent. Thus, the second metal trace does not impact transmission of the electronic component area, such that the electronic component area can normally transmit light.

In an embodiment, the liquid crystal display panel includes a display area including a source/drain layer, and material of the source/drain layer is a transparent material.

In an embodiment, the transparent material includes, but is not limited to, indium tin oxide. A metal disposed at a boundary around the display area and the electronic component is made of a transparent material, such as indium tin oxide, such that the electronic component area can normally transmit light and work normally.

In an embodiment, considering that the metal layer of the liquid crystal display panel is made of a transparent material, the metal layer can be disposed over the entire surface, that is, the metal trace can be disposed in the electronic component area, and the metal trace does not impact the transmittance of the electronic component area. By setting the metal trace in the electronic component area, a spacing between the metal traces can be increased without increasing the border of the liquid crystal display panel, thereby preventing metal traces from having too small pitch to result in short-circuit. In addition, a cross-sectional area of the metal traces can be increased, so that the metal traces have better performance. For example, the metal traces are not easy to be blown when current or voltage passes, and resistance of the metal traces is smaller, thus improving the display effect of the liquid crystal display panel, and reducing a probability of failure of the liquid crystal display panel.

In this embodiment of the present invention, the electronic component area is formed into the liquid crystals and the retaining walls, wherein the retaining walls are transparent and do not impact the display of the electronic component area, and for the electronic component area provided with liquid crystals, the transmittance of the electronic component area is increased.

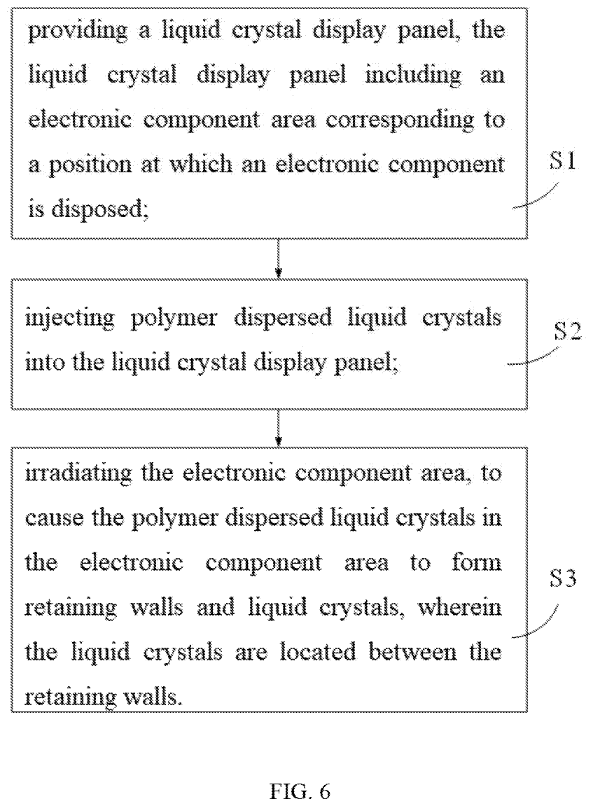

As shown in FIG. 6, this embodiment of the present invention provides a method of fabricating a liquid crystal display panel, which includes:

S1, providing a liquid crystal display panel, the liquid crystal display panel including an electronic component area corresponding to a position at which an electronic component is disposed;

S2, injecting polymer dispersed liquid crystals into the liquid crystal display panel; and

S3, irradiating the electronic component area, to cause the polymer dispersed liquid crystals in the electronic component area to form retaining walls and liquid crystals, wherein the liquid crystals are located between the retaining walls.

The embodiment of the present invention provides a method of fabricating a liquid crystal display panel, wherein the liquid crystal display panel includes an electronic component area corresponding to a position at which an electronic component is disposed, wherein the electronic component area is provided with polymer dispersed liquid crystals, which are processed to form retaining walls and liquid crystals located between the retaining walls. By disposing polymer dispersed liquid crystals in the electronic component area, and processing the polymer dispersed liquid crystals to form the retaining walls and the liquid crystals, the electronic component area and the display area can be separated by the retaining walls instead of being separated by a border, thereby eliminating the border between the electronic component area and the display area, thus improving the screen-to-body ratio. Moreover, the liquid crystals and the retaining walls are transparent, so that the electronic component area can normally transmit light, which solves the technical problem that the display screen of the existing mobile phone display screen has a border between the notch area and the display area.

In an embodiment, the step of irradiating the electronic component area includes irradiating the electronic component area with ultraviolet light through a mask, such that the electronic component area can be formed into the retaining walls and the liquid crystals, the electronic component area and the display area can be directly connected, and the electronic component area and the display area can be separated by the retaining walls, thereby eliminating a border between the electronic component area and the display areas.

In an embodiment, the electronic component area is irradiated with vertically and horizontally interlaced ultraviolet light through the mask, to form the vertically and horizontally interlaced retaining walls and the liquid crystals located between the retaining walls, such as the retaining walls and the liquid crystals in the electronic component area in FIG. 2, such that the electronic component area and the display area are separated by the retaining walls.

In an embodiment, the ultraviolet light is used to irradiate the electronic component area through a vertically and horizontally interlaced mask, such that the electronic component area forms the vertically and horizontally interlaced retaining walls and liquid crystals between the retaining walls, such as the retaining walls and the liquid crystals in the electronic component area in FIG. 2, such that the electronic component area and the display area are separated by the retaining walls.

In an embodiment, the step of injecting polymer dispersed liquid crystals into the liquid crystal display panel includes: injecting polymer dispersed liquid crystals into the liquid crystal display panel by using a liquid crystal pre-drop technique, which includes dropping the polymer dispersed liquid crystals into the sealant area, filling the display area and the electronic component area with the polymer dispersed liquid crystals by a surface tension of the polymer dispersed liquid crystals, and then assembling the first substrate and the second substrate.

In an embodiment, the liquid crystal cell may be filled with the polymer dispersed liquid crystals after the liquid crystal cell is formed, and the ultraviolet light is used to irradiate the electronic component area through a mask, so that the electronic component area forms the retaining walls and the liquid crystals, and the electronic component area and the display area are separated by the retaining walls.

In this embodiment of the present invention, since border packaging is not required between the electronic component area and the display area, a process of packaging between the display area and the electronic component area can be omitted when the liquid crystal display panel is fabricated, and the efficiency of the liquid crystal display panel is improved.

An embodiment of the present invention provides a liquid crystal display device including a liquid crystal display panel, a backlight module, and an electronic component, wherein the liquid crystal display panel includes an electronic component area corresponding to a position at which an electronic component is disposed, wherein the electronic component area is provided with polymer dispersed liquid crystals, which are processed to form retaining walls and liquid crystals located between the retaining walls.

An embodiment of the present invention provides a liquid crystal display device including a liquid crystal display panel, a backlight module, and an electronic component, wherein the liquid crystal display panel includes an electronic component area corresponding to a position at which an electronic component is disposed, wherein the electronic component area is provided with polymer dispersed liquid crystals, which are processed to form retaining walls and liquid crystals located between the retaining walls. By disposing polymer dispersed liquid crystals in the electronic component area, and processing the polymer dispersed liquid crystals to form the retaining walls and the liquid crystals, the electronic component area and the display area can be separated by the retaining walls instead of being separated by a border, thereby eliminating the border between the electronic component area and the display area, thus improving the screen-to-body ratio. Moreover, the liquid crystals and the retaining walls are transparent, so that the electronic component area can normally transmit light, which solves the technical problem that the display screen of the existing mobile phone display screen has a border between the notch area and the display area.

In an embodiment, the electronic component includes a camera disposed in the corresponding electronic component area, and the liquid crystals and the retaining walls are formed by processing the polymer dispersed liquid crystals in the electronic component area, thereby eliminating the border between the display area and the electronic component area. Since the liquid crystals and the retaining walls are both transparent, and the area where the liquid crystals are provided has an improved transmittance compared with the electronic component area, so that the light received by the camera is clearer and more realistic, thus improving the image capturing effect of the camera.

In an embodiment, the electronic component includes an infrared sensor. Since the liquid crystals and the retaining walls disposed in the electronic component area improve the transmittance of the electronic component area, the infrared sensor disposed in the electronic component area can receive a more realistic image, thereby reacting more quickly and accurately.

In an embodiment, the electronic component is disposed between the backlight module and the liquid crystal display panel. In the electronic component area, the backlight module is not provided with a light source. Since the electronic component area is not configured to display, it is not necessary to set the light source in an area of the backlight module corresponding to the electronic component area, thus preventing the problem that the light source of the backlight module disposed in the corresponding electronic component area impacts operation of the electronic component.

In an embodiment, the electronic component is disposed between the backlight module and the liquid crystal display panel. In the electronic component area, the backlight module is provided with a light source, and a light shielding plate is arranged on a side of the electronic component close to the backlight module. In consideration of obtaining stronger light, light sources are disposed on an entire surface of the backlight module, and the light shielding plate is disposed on a side of the electronic component close to the backlight module, so that the light source does not impact normal operation of the electronic component.

In an embodiment, the light shielding plate may be disposed around the electronic component, but only not on a side of the electronic component close to the liquid crystal display panel, so that the electronic component area does not have light leakage, and the electronic component can be better protected from the impact of the light source.

In an embodiment, the electronic component is disposed in a direction of the backlight module away from the liquid crystal display panel. The electronic component can be normally operated by digging an opening in a backlight module, or by setting a region of the backlight module corresponding to the electronic component area to be transparent.

According to the above embodiments, it can be known that:

The embodiments of the present invention provides a liquid crystal display panel, a method of fabricating the same, and a liquid crystal display device, wherein the liquid crystal display panel includes an electronic component area corresponding to a position at which an electronic component is disposed, wherein the electronic component area is provided with polymer dispersed liquid crystals, which are processed to form retaining walls and liquid crystals located between the retaining walls. By disposing polymer dispersed liquid crystals in the electronic component area, and processing the polymer dispersed liquid crystals to form the retaining walls and the liquid crystals, the electronic component area and the display area can be separated by the retaining walls instead of being separated by a border, thereby eliminating the border between the electronic component area and the display area, thus improving the screen-to-body ratio. Moreover, the liquid crystals and the retaining walls are transparent, so that the electronic component area can normally transmit light, which solves the technical problem that the display screen of the existing mobile phone display screen has a border between the notch area and the display area.

While the invention has been described by way of example and in terms of the preferred embodiments, it is to be understood that the invention is not limited to the disclosed embodiments. To the contrary, it is intended to cover various modifications and similar arrangements. Therefore, the scope of the appended claims should be accorded the broadest interpretation so as to encompass all such modifications and similar arrangements.

What is claimed is:

1. A liquid crystal display panel, comprising an electronic component area corresponding to a position at which an electronic component is disposed, wherein the electronic component area is provided with polymer dispersed liquid crystals, which are processed to form retaining walls and liquid crystals located between the retaining walls.

2. The liquid crystal display panel according to claim 1, further comprising a display area, wherein the display area comprises a first display area and a second display area located between the first display area and the electronic component area, the second display area comprises a first metal trace, and material of the first metal trace comprises a transparent material.

3. The liquid crystal display panel according to claim 1, further comprising a display area, wherein the display area comprises a first metal layer, and material of the first metal layer comprises a transparent material.

4. The liquid crystal display panel according to claim 3, wherein the display area comprises a second metal layer and an insulating layer, the insulating layer is disposed between the first metal layer and the second metal layer, and material of the second metal layer comprises a transparent material.

5. The liquid crystal display panel according to claim 1, further comprising a display area and a sealant area, wherein the electronic component area is disposed at a side of the display area, the electronic component area is disposed outside of the display area, and the sealant area is disposed around a boundary of the liquid crystal display panel.

6. The liquid crystal display panel according to claim 5, wherein the electronic component area has a semicircular shape.

7. The liquid crystal display panel according to claim 5, wherein the electronic component area has a trapezoidal shape.

8. The liquid crystal display panel according to claim 1, further comprising a display area and a sealant area, wherein the display area is disposed around the electronic component area, and the sealant area is disposed around the display area.

9. The liquid crystal display panel according to claim 8, wherein the electronic component area has a circular shape.

10. A method of fabricating a liquid crystal display panel, comprising:
providing a liquid crystal display panel, the liquid crystal display panel comprising an electronic component area corresponding to a position at which an electronic component is disposed;
injecting polymer dispersed liquid crystals into the liquid crystal display panel; and
irradiating the electronic component area, to cause the polymer dispersed liquid crystals in the electronic component area to form retaining walls and liquid crystals, wherein the liquid crystals are located between the retaining walls.

11. The method of fabricating the liquid crystal display panel according to claim 10, wherein irradiating the electronic component area comprises irradiating the electronic component area with ultraviolet light through a mask.

12. A liquid crystal display device, comprising a liquid crystal display panel, a backlight module, and an electronic component, wherein the liquid crystal display panel comprises an electronic component area corresponding to a position at which an electronic component is disposed, wherein the electronic component area is provided with polymer dispersed liquid crystals, which are processed to form retaining walls and liquid crystals located between the retaining walls.

13. The liquid crystal display device according to claim 12, wherein the liquid crystal display panel further comprises a display area, the display area comprising a first display area and a second display area located between the first display area and the electronic component area, the second display area comprising a first metal trace, and material of the first metal trace being a transparent material.

14. The liquid crystal display device according to claim 12, wherein the liquid crystal display panel further comprises a display area, the display area comprising a first metal layer, and material of the first metal layer is a transparent material.

15. The liquid crystal display device according to claim 14, wherein the display area comprises a second metal layer and an insulating layer, the insulating layer being disposed between the first metal layer and the second metal layer, and material of the second metal layer being a transparent material.

16. The liquid crystal display device according to claim 12, wherein the liquid crystal display panel further comprises a display area and a sealant area, wherein the electronic component area is disposed at a side of the display area, the electronic component arranging area is disposed outside of the display area, and the sealant area is disposed around a boundary of the liquid crystal display panel.

17. The liquid crystal display device according to claim 16, wherein the electronic component area has a semicircular shape.

18. The liquid crystal display device according to claim 16, wherein the electronic component area has a trapezoidal shape.

19. The liquid crystal display device according to claim 12, wherein the liquid crystal display panel further comprises a display area and a sealant area, the display area is disposed around the electronic component arranging area, and the sealant area is disposed around the display area.

20. The liquid crystal display device according to claim 19, wherein the electronic component area has a circular shape.
